(19) United States
(12) Patent Application Publication
(10) Pub. No.: US 2011/0149574 A1
(43) Pub. Date: Jun. 23, 2011

(54) ILLUMINATION SYSTEM

(75) Inventors: Po-Heng Lin, Hualien County (TW); Chien-Sheng Liu, Tainan County (TW); Chia-Hsu Chen, Kaohsiung City (TW); Yi-Hsuan Chiang, Pingtung County (TW)

(73) Assignee: INDUSTRIAL TECHNOLOGY RESEARCH INSTITUTE, Hsinchu (TW)

(21) Appl. No.: 12/729,249

(22) Filed: Mar. 23, 2010

(30) Foreign Application Priority Data
Dec. 22, 2009 (TW) 98144316

(51) Int. Cl. G02B 27/48; F21V 17/02

(52) U.S. Cl. 362/259; 362/282

(57) ABSTRACT

An illumination system including a light source and a magneto-optical device is provided. The light source is adapted to emit a beam, and at least a part of the beam is polarized. The magneto-optical device is disposed in a transmission path of the beam and includes a plurality of magneto-optical material units. The magneto-optical material units are adapted to be disposed in the transmission path of the beam, and at least a part of the magneto-optical material units has different optical rotation. The magneto-optical device is adapted to move so as to make the magneto-optical material units move with respect to the beam.

### CROSS-REFERENCE TO RELATED APPLICATION

This application claims the priority benefit of Taiwan application serial no. 98144316, filed on Dec. 22, 2009. The entirety of the above-mentioned patent application is hereby incorporated by reference herein and made a part of specification.

### BACKGROUND OF THE INVENTION

1. Field of the Invention

The invention generally relates to an illumination system, and more particularly to an illumination system that reduces speckle.

2. Description of Related Art

With the rapid advancement of technology, many physical or biological phenomenons previously unexplained by engineering and science have begun to reveal their mechanisms or interactions, due in large part to the evolution of imaging devices that allow observation and in-depth research into such mysteries. Yet as scientific progress continues to forge forward, conventional image detection devices have gradually become incapable of handling the high-speed and multi-sampling demands of the increasing complexities in biomedical, physical and chemical research, as well as micro fluidic analysis and rapid manufacturing. Therefore, by increasing the resolutions of an image detection device, such as a color, time, space, and size resolution, the image detection device may aid in further observation and study of biomedical, physical and chemical research, as well as micro fluidic analysis and rapid manufacturing.

In the evolution of the image detection device, because an image captured with a laser has a superior image quality and a high resolution, the white light exposure source has been largely replaced by the laser exposure source. Moreover, a laser source may be used as a light source for a projection device. Since light emitted by the laser source has a high color purity, the image projected by the projection device has a substantially wider color gamut.

However, since a laser beam emitted by the laser source exhibits a high coherence, therefore when the laser beam illuminates onto a surface of a rough object, the laser beam scattered by the object surface produces a speckle pattern on a pair of human eyes or on an image detection device due to interference. Here, the speckle pattern is an irregular and noisy pattern. As this speckle phenomenon results in irregular bright and dark spots in the images, an optical quality of the image detection device and the projection device deteriorates.

### SUMMARY OF THE INVENTION

An aspect of the invention provides an illumination system capable of effectively reducing speckle.

An embodiment of the invention provides an illumination system, including a light source and a magneto-optical device. The light source is adapted to emit a beam, and at least a part of the beam is polarized. The magneto-optical device is disposed in a transmission path of the beam and includes a plurality of magneto-optical material units. The magneto-optical material units are adapted to be disposed in the transmission path of the beam, and at least a part of the magneto-optical material units has different optical rotation. The magneto-optical device is adapted to move so as to make the magneto-optical material units move with respect to the beam.

In summary, according to an embodiment of the invention, an illumination system adopts a magneto-optical device adaptable to move so as to randomize a beam polarization, thereby rendering the polarizations of a plurality of sub-beams forming the beam in a random spatial distribution which also varies with time. Accordingly, speckle may be effectively reduced.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is schematic structural view of an illumination system in accordance with an embodiment of the invention.

FIG. 1B is a front view of a magneto-optical device depicted in FIG. 1A.

FIG. 2A is a schematic cross-sectional view of a beam depicted in FIG. 1A along line I-I.

FIG. 2B is a schematic cross-sectional view of the magneto-optical device depicted in FIG. 1A along line II-II.

FIG. 2C is a schematic cross-sectional view of the beam depicted in FIG. 1A along line III-III.

FIG. 3 is a schematic structural view of an illumination system in accordance with another embodiment of the invention.

FIG. 4 is a schematic structural view of an illumination system in accordance with another embodiment of the invention.

### DESCRIPTION OF EMBODIMENTS

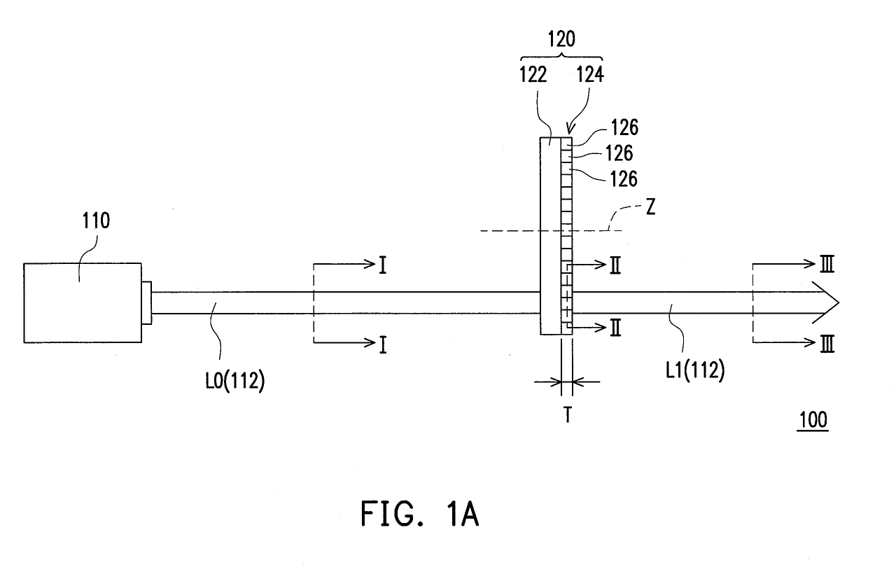

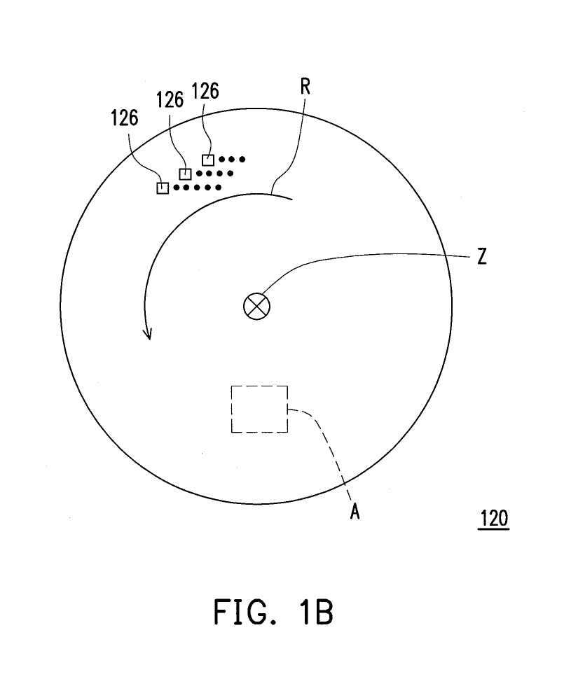

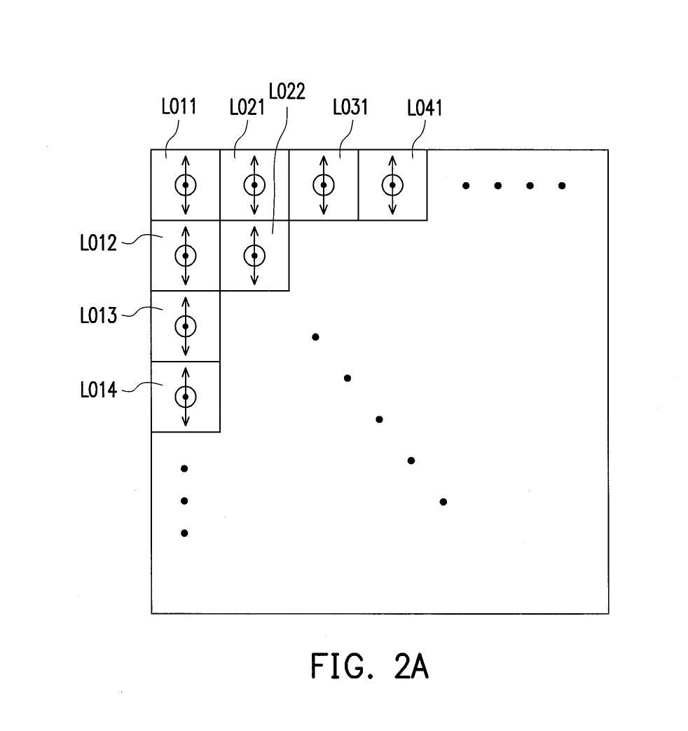

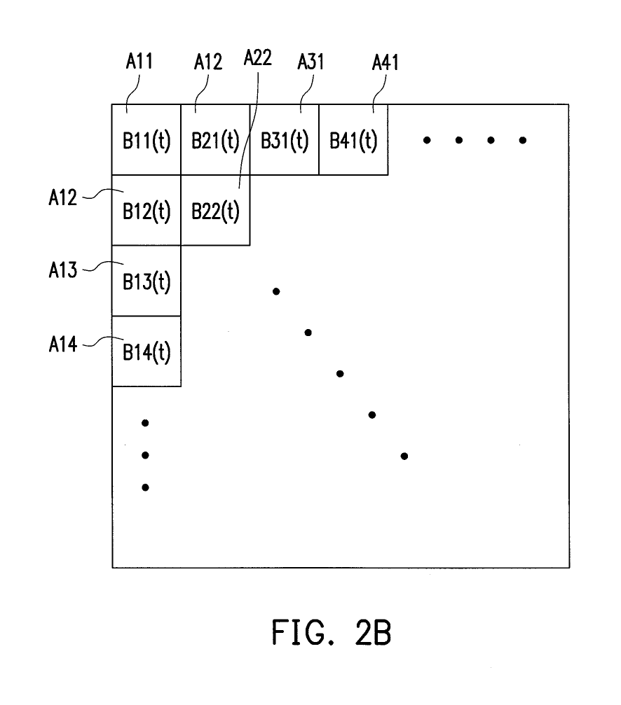

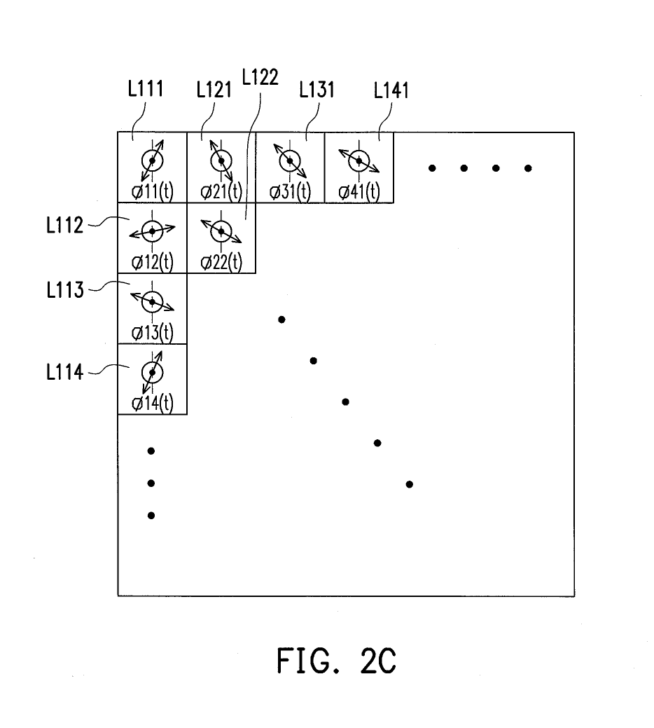

FIG. 1A is a schematic structural view of an illumination system in accordance with an embodiment of the invention. FIG. 1B is a front view of a magneto-optical device depicted in FIG. 1A. FIG. 2A is a schematic cross-sectional view of a beam depicted in FIG. 1A along line I-I. FIG. 2B is a schematic cross-sectional view of the magneto-optical device depicted in FIG. 1A along line II-II. FIG. 2C is a schematic cross-sectional view of the beam depicted in FIG. 1A along line III-III.

Referring to both FIGS. 1A and 1B, an illumination system 100 of the present embodiment of the invention includes a light source 110 and a magneto-optical device 120. The light source 110 is adapted to emit a beam 112, and at least a part of the beam 112 is polarized. In the present embodiment, the light source 110 may be a laser generator, for example, and the beam 112 is a laser beam, for example. That is, the beam 112 is a coherent beam, for example, and the laser beam is a substantially linear polarized beam. However, as persons of ordinary skill in the art may well realize, in other embodiments of the invention, the beam 112 may be other types of polarized beams, such as a circular polarized beam, a elliptical polarized beam, or other incoherent polarized beams. In the present embodiment of the invention, the light source 110 is a continuous wave laser generator, for example, that is adapted to emit continuous laser beams, although the invention is not limited thereto. However, in other embodiments of the invention, the light source 110 may be a pulse laser generator adapted to emit pulses of laser beams.

The magneto-optical device 120 is disposed in a transmission path of the beam 112 and includes a plurality of magneto-optical material units 126. The magneto-optical material units 126 are adapted to be disposed in the transmission path of the beam 112, and at least parts of the magneto-optical material units have different optical rotation. The magneto-optical device 120 is adapted to move so as to make the magneto-optical material units 126 move with respect to the beam 112.

In order to facilitate description, FIG. 1A designates the beam 112 which has yet to pass through the magneto-optical device 120 as L0, and designates the beam 112 which has passed through the magneto-optical device 120 as L1. In the present embodiment of the invention, the magneto-optical device 120 is adapted to move, for example, by rotating around a rotational axis Z (e.g., rotation along a rotational direction R as illustrated in FIG. 1B), so as to cause a spatial distribution of the magneto-optical material units 126 in an illumination region of the beam 112 (i.e., the beam L0) to vary over time. However, in other embodiments of the invention, the magneto-optical device 120 may also, through a shift, vary the spatial distribution of the magneto-optical material units 126 in the illumination region of the beam 112 (i.e., the beam L0) over time. Alternatively, in other embodiments, the magneto-optical device 120 may also, through a concurrent rotation and shift, vary the spatial distribution of the magneto-optical material units 126 in the illumination region of the beam 112 (i.e., the beam L0) over time.

According to the illumination system 100 of the present embodiment, since at least parts of the magneto-optical material units have different optical rotation, and because the magneto-optical material units move with respect to the beam, therefore the spatial distribution of the magneto-optical material units 126 in the illumination region of the beam 112 varies over time. In other words, a spatial distribution of the optical rotation of the magneto-optical device 120 in the illumination region of the beam 112 varies over time. Consequently, for a polarization of a plurality of sub-beams of the beam 112 illuminated on the magneto-optical material units 126, the polarization thereof may be affected by the variation of the spatial distribution of the optical rotation over time. Hence, at least partially, different polarizations are generated at different locations and times. Due to differences in reflection, scatter, and interference effects for light of different polarizations, when the beam 112 (i.e., the beam L1) which passes through the magneto-optical device 120 is illuminated on an illumination object, speckle may be effectively suppressed.

In the present embodiment of the invention, the magneto-optical device 120 includes a substrate 122 disposed in the transmission path of the beam 112. Moreover, the magneto-optical material units 126 are disposed on the substrate 122. In the present embodiment, the substrate 122 is a transparent substrate, for example, although the invention is not limited thereto. In addition, the magneto-optical device 120 is adapted to allow the beam to penetrate therethrough. Moreover, in the present embodiment, the magneto-optical material units 126 form a magneto-optical material film 124. A material of the magneto-optical units 126 includes gadolinium-iron-cobalt (GdFeCo), terbium-iron-cobalt (TbFeCo), magneto-optical glass (terbium-aluminoborosilicate), doped Yttrium Aluminum Garnet (YAG), or a combination of the aforesaid materials. It should be noted that, the invention does not limit the material of the magneto-optical material units 126 to the aforesaid materials. In other embodiments of the invention, the material of the magneto-optical material units 126 may include other magneto-optical materials.

The optical rotation and various parameters of the magneto-optical material units 126 may be related according to a formula below:

φ=V·B·d

φ is a polarization rotational angle of the polarized light after passing through the magneto-optical material units 126 (i.e., the optical rotation), V is the Verdet constant, B is a magnetic flux density of the magneto-optical material units 126 in a direction parallel to a transmitting direction of the beam 112, and d is a thickness T of the magneto-optical material units 126 in a direction parallel to the transmitting direction of the beam 112. In the present embodiment, by configuring the magneto-optical units 126 such that at least a part of the magnetic flux densities is different in a direction parallel to the transmitting direction of the beam 112, at least a part of the magneto-optical units 126 has different optical rotation. However, in other embodiments of the invention, the optical rotation of a part of the magneto-optical material units 126 may be made different by varying the Verdet constants of the magneto-optical material units 126, or by configuring at least a part of the magneto-optical material units 126 to have different thicknesses T. Alternatively, in the other embodiments, by adjusting at least two of the Verdet constant, the thickness T, or the magnetic flux density of at least a part of the magneto-optical material units 126 to vary, thereby at least a part of the magneto-optical material units 126 may be configured to have different optical rotation.

In the present embodiment, the optical rotation of the magneto-optical material units 126 exhibits a random spatial distribution, thereby enhancing a speckle reduction effect of the magneto-optical device 120. The random spatial distribution of the optical rotation may be implemented by randomly spatially distributing at least one of the Verdet constant, the thickness T, or the magnetic flux density of the magneto-optical material units 126.

It should be noted that, the magneto-optical material units 126 may be integrally formed as the magneto-optical material film 124. On the magneto-optical material film 124, the optical rotation at different locations vary continuously in space, and the magneto-optical material units 126 are merely a plurality of micro regions that are human defined. However, in other embodiments of the invention, each of the magneto-optical material units 126 may be a tiny physical region. For example, two neighboring magneto-optical material units 126 may adopt different materials or thicknesses and may be physically divided into two different regions. It should be noted that, the invention does not limit the magneto-optical material units 126 to a rectangular shape, and the invention does not limit the magneto-optical material units 126 to a rectangular array arrangement. In other embodiments of the invention, after referring to the invention, persons of ordinary knowledge in the art may configure the magneto-optical material units 126 in other geometrical shapes or irregular shapes, and they may arrange the magneto-optical material units 126 in other shapes of arrays, in another arrangement manner, or in an irregular arrangement.

By varying magnetic flux densities to produce different optical rotation, the magneto-optical device 120 has a simple fabrication process and a low cost. For example, in a fabrication process of the magneto-optical device 120, the magneto-optical device 120 may be heated, and a magnetic head may be employed to sequentially magnetize the magneto-optical material units 126 to different degrees. By returning the magneto-optical device 120 to a normal temperature, the fabrication of the magneto-optical device 120 is completed. Other principles (e.g., exploiting an optical path change or an optical phase change) to suppress speckle may result in a reduction in usable light and high costs, making wide applicability difficult. Compared with these implementations, the simple fabrication process and low cost of the magneto-optical device 120 in present embodiment may allow the illumination system 100 of the present embodiment to be easily mass produced and widely applied. The illumination system 100 of the present embodiment may be adapted in high speed pulse laser photography techniques or laser projection techniques, and the illumination system 100 may achieve a preferred optical effect therein.

Referring to FIGS. 1A and 2A-2C, the plurality of magneto-optical material units 126 in a region A of the magneto-optical device 120 depicted in FIG. 1B may be labeled as A11, A12, A13, A14, . . . , A21, A22, . . . , A31, . . . , A41, . . . etc. (as shown in FIG. 2B) according to an arrangement order in a 2-dimensional (2D) space. Moreover, the beam L0 may be divided into a plurality of sub-beams L011, L012, L013, L014, . . . , L021, L022, . . . , L031, . . . , L041, . . . etc. (as shown in FIG. 2A). The sub-beams L011, L012, L013, L014, . . . , L021, L022, . . . , L031, . . . , L041 . . . respectively illuminate the magneto-optical material units A11, A12, A13, A14, . . . , A21, A22, . . . , A31, . . . , A41, . . . . The magnetic flux densities of the magneto-optical material units A11, A12, A13, A14, . . . , A21, A22, . . . , A31, . . . , A41, . . . in the direction parallel to the transmitting direction of the beam 112 are respectively labeled as B11(t), B12(t), B13(t), B14(t), . . . , B21(t), B22(t), . . . , B31(t), . . . , B41(t), . . . . The magnetic flux densities are functions of a time t. That is, the magnetic flux densities varies with respect to time. This is due to in different times, different combinations of the magneto-optical material units 126 enter the transmission path of the beam 112 and enter the region A. Moreover, since the magnetic flux densities of the magneto-optical material units 126 have a random spatial distribution, the magnetic flux densities in the region A are distributed such that they exhibit different states at different times. As shown in FIG. 2C, after the beam L0 passes through the magneto-optical device 120, the polarization rotational angles of the sub-beams L111, L112, L113, L114, . . . , L121, L122, . . . , L131, . . . , L141 . . . of the beam L1 with respect to the polarization of the sub-beams L011, L012, L013, L014, . . . , L021, L022, . . . , L031, . . . , L041 . . . are, respectively, φ11(t), φ12(t), φ13(t), φ14(t), . . . , φ21(t), φ22(t), . . . , φ31(t), . . . , φ41(t), . . . . In other words, not only do the polarization states have a random spatial distribution, they also vary over time (i.e., functions of time t). Therefore, when the illumination object is illuminated by the beam L1, speckle may be effectively suppressed.

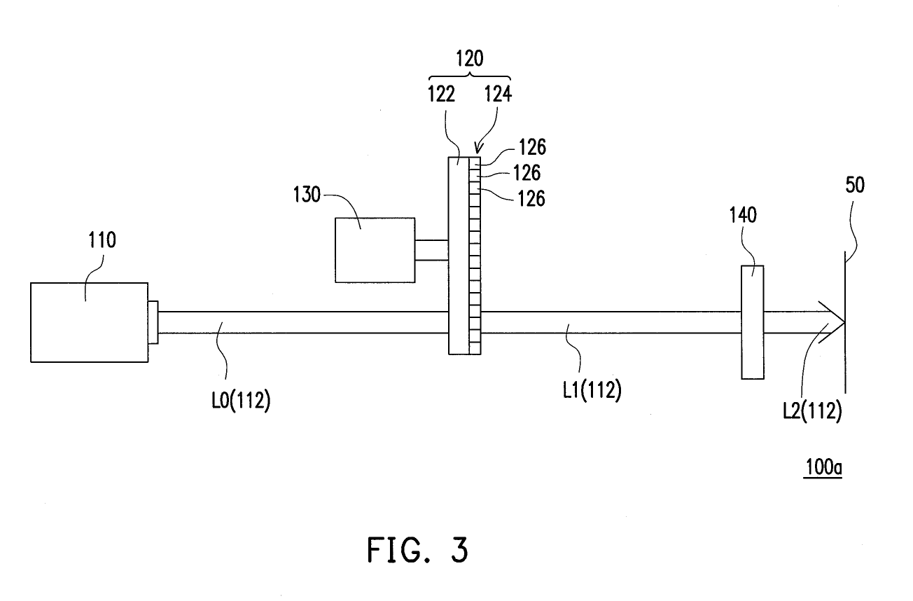

FIG. 3 is a schematic structural view of an illumination system in accordance with another embodiment of the invention. Referring to FIG. 3, the illumination system 100a of the present embodiment is similar to the illumination system 100 depicted in FIG. 1A. The dissimilarities are described below. The illumination system of the present embodiment further includes an actuator 130 connected to the magneto-optical device, so as to drive the magneto-optical device 120 to move. The actuator 130 is, for example, an electromagnetic actuator, a piezoelectric actuator, a pneumatic actuator, a hydraulic actuator, or actuators employing other physical principles. In the present embodiment of the invention, the actuator 130 is a motor, for example, that is adapted to drive the magneto-optical device 120 to rotate, although the invention is not limited thereto. However, in other embodiments of the invention, the actuator 130 may also drive the magneto-optical device 120 to shift, or drive the magneto-optical device 120 to both rotate and shift.

The illumination system 100a of the present embodiment is similar to the illumination system 100 depicted in FIG. 1A. The dissimilarities are described below. The illumination system 100a of the present embodiment further includes a light uniforming device 140. In order to facilitate description, FIG. 3 designates the beam 112 which has yet to pass through the light uniforming device 140 as L1, and designates the beam 112 which has passed through the light uniforming device 140 as L2. The light uniforming device 140 is disposed in a transmission path of the beam 112 (i.e., the beam L1) from the magneto-optical device 120. The light uniforming device 140 is adapted to make the beam 112 uniform, so that the beam 112 (i.e., the beam L1) after passing through the light uniforming device 140 (i.e., becoming the beam L2 after passage) may uniformly illuminate an illumination object 50. The light uniforming device 140 is, for example, a light integration rod, a lens array, or other suitable beam shaping devices. When the illumination system 100a is applied in an image detection system, the illumination object 50 is an object to be tested. When the illumination system 100a is applied in a projection system, the illumination object 50 is a screen. Moreover, a spatial light modulator may be disposed between the illumination object 50 and the light uniforming device 140, so as to generate an image.

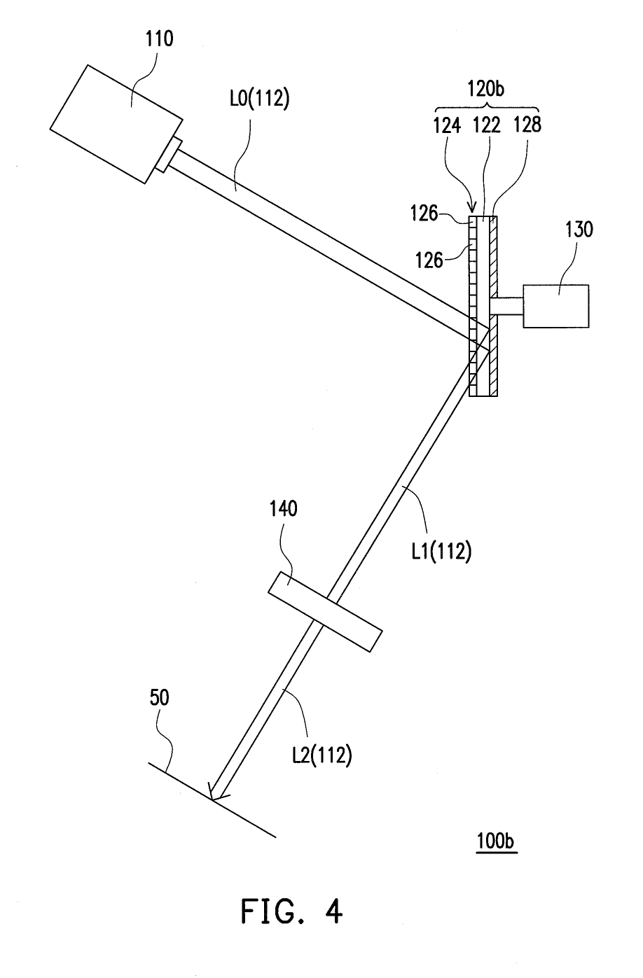

FIG. 4 is a schematic structural view of an illumination system in accordance with another embodiment of the invention. An illumination system 100b of the present embodiment is similar to the illumination system 100a depicted in FIG. 3. The dissimilarities are described below. In the illumination system 100b of the present embodiment, an magneto-optical device 120b further includes a reflective film 128 disposed on the substrate 122 (i.e., the transparent substrate), so as to reflect the beam 112. Accordingly, a light path may be bent, such that the present embodiment may be suitably applied in various systems. In other embodiments of the invention, the substrate may be a reflector having a reflective film coated thereon to reflect the beam 112, or the reflector itself may be made of reflective materials which may reflect the beam 112 without film coating.

In light of the foregoing, according to an embodiment of the invention, an illumination system adopts a magneto-optical device adaptable to move so as to randomize a beam polarization, thereby rendering the polarizations of a plurality of sub-beams forming the beam in a random spatial distribution which also varies with time. Accordingly, speckle may be effectively reduced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An illumination system, comprising:
a light source adapted to emit a beam, wherein at least a part of the beam is polarized; and
a magneto-optical device disposed in a transmission path of the beam, including a plurality of magneto-optical material units, wherein the magneto-optical material units are adapted to be disposed in the transmission path of the beam, at least a part of the magneto-optical material units has different optical rotation, and the magneto-optical device is adapted to move so as to make the magneto-optical material units move with respect to the beam.

2. The illumination system as claimed in claim 1, wherein at least a part of the magneto-optical material units has different Verdet constants.

3. The illumination system as claimed in claim 1, wherein at least a part of the magneto-optical material units has different thicknesses.

4. The illumination system as claimed in claim 1, wherein at least a part of the magneto-optical material units has different magnetic flux densities in a direction parallel to a transmitting direction of the beam.

5. The illumination system as claimed in claim 1, wherein the magneto-optical device comprises a substrate disposed in the transmission path of the beam, wherein the magneto-optical material units are disposed on the substrate.

6. The illumination system as claimed in claim 5, wherein the substrate is a reflector for reflecting the beam.

7. The illumination system as claimed in claim 5, wherein the substrate is a transparent substrate, and the magneto-optical device is adapted to allow the beam to penetrate.

8. The illumination system as claimed in claim 5, wherein the substrate is a transparent substrate, and the magneto-optical device further comprises a reflective film disposed on the transparent substrate.

9. The illumination system as claimed in claim 1, wherein the magneto-optical material units form a magneto-optical material film.

10. The illumination system as claimed in claim 1, wherein an optical rotation of the magneto-optical material units has a random spatial distribution.

11. The illumination system as claimed in claim 1, further comprising an actuator connected to the magneto-optical device for driving the magneto-optical device to move.

12. The illumination system as claimed in claim 11, wherein the actuator is adapted to drive the magneto-optical device to rotate.

13. The illumination system as claimed in claim 11, wherein the actuator is adapted to drive the magneto-optical device to shift.

14. The illumination system as claimed in claim 11, wherein the actuator is an electromagnetic actuator, a piezoelectric actuator, a pneumatic actuator, or a hydraulic actuator.

15. The illumination system as claimed in claim 1, wherein the light source is a laser generator, and the beam is a laser beam.

16. The illumination system as claimed in claim 15, wherein the laser generator is a continuous wave laser generator or a pulse laser generator.

17. The illumination system as claimed in claim 1, further comprising a light uniforming device disposed in a transmission path of the beam from the magneto-optical device.
